(19) United States
(12) Patent Application Publication
(10) Pub. No.: US 2025/0382503 A1
(43) Pub. Date: Dec. 18, 2025

(54) The composition and thermal curable adhesive film derived thereof

(71) Applicant: Henkel AG & Co. KGaA, Duesseldorf (DE)

(72) Inventors: YiZhong Luo, Shanghai (CN); DongMei Shen, Shanghai (CN)

(21) Appl. No.: 19/316,246

(22) Filed: Sep. 2, 2025

Related U.S. Application Data
(63) Continuation of application No. PCT/CN2023/081533, filed on Mar. 15, 2023.

(51) Int. Cl. C09J 7/35; B32B 7/12; B32B 27/06; B32B 27/30; B32B 27/36; B32B 27/40

(52) U.S. Cl. CPC C09J 7/35; B32B 7/12; B32B 27/06; B32B 27/302; B32B 27/308; B32B 27/36; B32B 27/40; B32B 2307/54; C09J 2301/304

(57) ABSTRACT

The present invention provides a Composition and a thermal curable adhesive film derived thereof. The thermal curable adhesive film can be activatable at low temperature (lower than 100° C., preferably from 60° C. to 80° C.) and is capable of being self-supported and exhibiting excellent bonding strength when cured.

### TECHNICAL FIELD

The present invention relates to a Composition and a thermal curable adhesive film derived thereof. In particular, the thermal curable adhesive film that can be activatable at low temperature (lower than 100° C., preferably from 60° C. to 80° C.) and is capable of being self-supported and exhibiting excellent bonding strength when cured.

### BACKGROUND OF THE INVENTION

The use of thermal curable adhesive films has been widely used in manufacturing films for the assembling of substrates. The term “thermal curable” (or “thermally activatable) refers to the composition has latent adhesive properties which are only activated after being heated above a given temperature. Such thermal curable compositions have other advantages over solvent-based adhesive, such as simple and rapid to employ, the latter adhesive requires the evaporation of the solvent. During the manufacturing process, the thermal curable adhesive film is placed between the surfaces of the substrates to be assembled and held in contact with them while the assembly is heated to activate the adhesive composition. The heating time can vary with the thickness of the substrates but would not be too long to avoid the thermal deformation of the substrates. After cooling, an adhesive layer with certain bonding strength is obtained for the assembling of the substrates.

Current thermal curable adhesive films disclosed in prior art or existed on the market are based on polyols and NCO-terminated isocyanates. It has been observed that such adhesives exhibit very high activation temperature (above 160° C.). They have to be heated so high temperature in order to fully develop their adhesive properties. Failing that, the adhesive performance will be insufficient to provide effective bonding to the substrates. However, some substrates, such as polyolefin, polypropylene, degrades if it is heated above 160° C. While in cases, the adhesive film was observed to have not enough bonding strength when cured.

In view of the above, there is a need for a thermal curable adhesive film that can be activatable at low temperature (lower than 100° C., preferably from 60° C. to 80° C.) and is capable of being self-supported and exhibiting extraordinary bonding strength when cured.

### SUMMARY OF THE INVENTION

According to a first aspect of the invention, disclosed herein is a Composition comprising:
(A) at least one thermoplastic polymer having a weight-molecular weight (Mw) no less than 10,000 g/mol and an optimum activation temperature of no greater than 100° C.,
(B) at least one polyester polyol having a weight-molecular weight (Mw) less than 10,000 g/mol,
(C) at least one polyisocyanate having at least two isocyanate groups and at least one uretdione group in one molecule, and
(D) at least one organic solvent, wherein the organic solvent is present in an amount of greater than 36% to 95% based on the total weight of the Composition.

According to a second aspect of the invention, provided herein is a method for preparing a thermal curable adhesive film derived from the Composition according to the present invention.

According to a third aspect of the invention, provided herein is a thermal curable adhesive film derived from the Composition according to the present invention.

According to a fourth aspect of the invention, provided herein is an article, comprising a first substrate, a second substrate, and the thermal curable adhesive film according to according to the present invention disposed between the first substrate and the second substrate.

According to a fifth aspect of the invention, provided herein is the use of the Composition according to the present invention or the thermal curable adhesive film according to the present invention or the article the thermal curable adhesive film in manufacturing automobile parts, truck bed covers, textile laminations, assembled goods, and electronic devices.

Other features and aspects of the subject matter are set forth in greater detail below.

### DETAILED DESCRIPTION OF THE INVENTION

It is to be understood by one of ordinary skill in the art that the present invention is a description of exemplary embodiments only and is not intended as limiting the broader aspects of the present invention. Each aspect so described may be combined with any other aspect or aspects unless clearly indicated to the contrary. In particular, any feature indicated as being preferred or advantageous may be combined with any other feature or features indicated as being preferred or advantageous.

Unless specified otherwise, in the context of the present invention, the terms used are to be construed in accordance with the following definitions.

Unless specified otherwise, as used herein, the terms “a”, “an” and “the” include both singular and plural referents.

The terms “comprising” and “comprises” as used herein are synonymous with “including”, “includes” or “containing”, “contains”, and are inclusive or open-ended and do not exclude additional, non-recited members, elements or process steps.

The term “at least one” or “one or more” used herein to define a component refers to the type of the component, and not to the absolute number of molecules. For example, “one or more polyols” means one type of polyol or a mixture of a plurality of different polyols.

The term “thermal curable” (or “thermally activatable”) is understood to mean that the adhesive film has latent adhesive properties which are only activated after having heated said film above a given temperature (“activation temperature”). It is during this thermal activation stage that the film will develop its adhesive properties.

The term “adhesive film” means an adhesive in a form of a film.

The term “polyurethane” means polyurethane as well as polyurethane that contains urea groups in the backbone of the polyurethane.

The term “room temperature” as used herein refers to a temperature of about 20° C. to about 25° C., preferably about 25° C.

Unless specified otherwise, the recitation of numerical end points includes all numbers and fractions subsumed within the respective ranges, as well as the recited end points.

All references cited in the present specification are hereby incorporated by reference in their entirety.

The molecular weights refer to number average molecular weights (Mn), unless otherwise stipulated. All molecular weight data refer to values obtained by gel permeation chromatography (GPC), unless otherwise stipulated, e.g., according to DIN 55672.

The softening point mentioned herein is determined by using Ring and Ball method according to DIN ISO 4625.

Unless otherwise defined, all terms used in the present invention, including technical and scientific terms, have the meaning as commonly understood by one of the ordinary skilled in the art to which this invention belongs.

In one aspect, the present disclosure is generally directed to a Composition comprising:
(A) at least one thermoplastic polymer having a weight-molecular weight (Mw) no less than 10,000 g/mol and an optimum activation temperature of no greater than 100° C.,
(B) at least one polyester polyol having a weight-molecular weight (Mw) less than 10,000 g/mol,
(C) at least one polyisocyanate having at least two isocyanate groups and at least one uretdione group in one molecule, and
(D) at least one organic solvent, wherein the organic solvent is present in an amount of greater than 36% to 95% based on the total weight of the Composition.

### (A) Thermoplastic Polymer

According to the present invention, the Composition comprises (A) at least one thermoplastic polymer having a weight-molecular weight (Mw) no less than 10,000 g/mol and an optimum activation temperature of no greater than 100° C.

The thermoplastic polymer (A) provides the backbones to the thermal curable adhesive film derived from the Composition. Without containing such thermoplastic polymer (A), the thermal curable adhesive film derived from the Composition cannot realize a self-supporting adhesive film.

A thermoplastic polymer is distinct from a thermosetting polymer which solidifies via crosslinking or curing when subjected to heat and/or to a suitable curing agent, while a thermoplastic polymer that is pliable at elevated temperature and solidifies when cooled.

The term “optimum activation temperature” described herein means a temperature range (or point) of a thermoplastic polymer at which coalescence occurs within the thermoplastic polymer (physically) which has satisfactory strength with a proportion of non-coalescence of less than 10%. The optimum activation temperature of a thermoplastic polymer described herein can be determined according to EN 12961:2001.

In a preferred embodiment, the component (A) has an optimum activation temperature of less than 85° C., preferably from 30° C. to less than 80° C., much preferably from 30° C. to less than 70° C., even much preferably from 30° C. to less than 60° C. Within the preferred range, the thermal curable adhesive film derived from the Composition is capable of self-supporting and exhibiting certain bonding strength when cured.

Generally, the thermoplastic polymer described herein are non-reactive chemically, when subject to a heat, coalescence occurs and resulting in a pliable status with certain adhesive property. In some embodiments, the thermoplastic polymer may comprise hydroxyl groups that can react with component (C).

A wide variety of known thermoplastic polymers can be used in the present invention provided that the molecular weight and optimum activation temperature satisfy. Suitable thermoplastic polymer used in the present invention can be selected from groups consisting of thermoplastic polyurethane polymers, polyester polymers, acrylic polymers, ethylene-vinyl acetate copolymers, styrene block copolymers, polyvinyl acetols, styrene acrylonitriles, polyolefins, polyacrylonitriles, ethylene vinyl acetate terpolymers, functional ethylene vinyl acetates, ethylene acrylate copolymers, ethylene acrylate terpolymers, ethylene butadiene copolymers and/or block copolymers, preferably selected from thermoplastic polyurethane polymers, polyester polymers, acrylic polymers, styrene block copolymers, and combination thereof.

The thermoplastic polyurethane polymers having a weight-molecular weight (Mw) no less than 10,000 g/mol and an optimum activation temperature of no greater than 100° C. used as component (A) can be obtained from the reaction of ring opening polymerization of a lactone such as &-caprolactone, or polyester polyols and/or polyether polyols with diisocyanates and optionally also from the further reaction of such components with chain-extending agents such as low molecular weight polyols, preferably diols, or with diamines to form urea linkages.

Examples of useful polyester polyols used to prepare the thermoplastic polyurethane polymers include, e.g., polyester polyols derived from linear dicarboxylic acids, derivatives of dicarboxylic acids (e.g., anhydrides, esters and acid chlorides), aliphatic polyols, cycloaliphatic polyols, linear polyols, branched polyols, and combinations thereof. Examples of useful dicarboxylic acids from which the polyester polyol can be derived include adipic acid, succinic acid, sebacic acid, dodecanedioic acid, phthalic acid, isophthalic acid, terephthalic acid, phthalic anhydride and combinations thereof. Examples of useful aliphatic diols from which the polyester polyol can be derived include ethylene glycol, 1,3-propanediol, 1,4-butanediol, 1,5-pentanediol, 1, 6-hexanediol, neopentyl glycol, and combinations thereof.

Examples of useful polyether polyols used to prepare the thermoplastic polyurethane polymers can be obtained from the polymerization of a cyclic oxide, e.g., ethylene oxide, propylene oxide, butylene oxide, and tetrahydrofuran, or by the addition of one or more such oxides to polyfunctional initiators having at least two active hydrogens, e.g., water, polyhydric alcohols (e.g., ethylene glycol, propylene glycol, diethylene glycol, cyclohexane dimethanol, glycerol, trimethylol-propane, pentaerythritol and bisphenol A), ethylenediamine, propylenediamine, triethanolamine, and 1,2-propanedithiol.

Useful thermoplastic polyurethane polymers (A) are generally composed of soft segments, for example polyether or polyester polyols, and hard segments, usually derived from the reaction of the low molecular weight diols and diisocyanates. Commercially available thermoplastic polyurethane polymers used as component (A) include but not limited to Pearlstick series such as 5707, 5703, 5701, 5714, 5713, 5715, 45-40/05 TPU, 45-40/11STPU, 45-40/27TPU, 45-60/08 from Lubrizol, HF-4003LH, 3003EH series, HF-3H, 6H series from Huafeng Chemicals, and WHT-61, 63, 64, 65, 67 series from Wanhua Chemicals.

The polyester polymers having a weight-molecular weight (Mw) no less than 10,000 g/mol and an optimum activation temperature of no greater than 100° C. used as component (A) can be obtained by polycondensation of at least one polyester diol, such as ethylene glycol, diethylene glycol, trimethylene glycol, butanediol (1,4-butanediol; 1, 2-butanediol; 1,3-butanediol), neopentyl glycol, 2-methyl-1,3-propanediol, hexanediol (hexamethylene glycol), propanediol (propane-1,2-diol, propane-1,3-diol or propylene glycol), trimethylolpropane, cyclohexanedimethanol, or combination and of at least one dicarboxylic acid or one of its ester or anhydride derivatives, such as terephthalic acid, dimethyl terephthalate, isophthalic acid, adipic acid, azelaic acid, sebacic acid, cyclohexanedicarboxylic acid, dodecanoic acid (1,10-decanedicarboxylic acid), succinic acid, phthalic anhydride, maleic anhydride and hydroxycarboxylic acids, such as the diesters obtained from polycaprolactone or from ε-caprolactone and from diethylene glycol, or combination. Commercially available polyester polymers used as component (A) include but not limited to BX1001 manufactured by TOYOBO, CAPA™ 6800, 6500, 6400 under Perstorp, PLACCEL H series manufactured by Daicel, and PCL65000, PCL68000 from Hunan Juren Chemical.

The acrylic polymers having a weight-molecular weight (Mw) no less than 10,000 g/mol and an optimum activation temperature of no greater than 100° C. used as component (A) can be obtained by polymerization of esters of acrylic and methacrylic acid monomers. Exemplary useful monomers used to synthesis component (A) include the soft monomers such as ethyl acrylate, 2-ethylhexyl acrylate, n-butyl acrylate and hard monomers such as methyl methacrylate, isobutyl acrylate. Exemplary Acrylic polymers used as component (A) include polymethyl methacrylate, n-butyl acrylate-based block copolymers, n-butyl acrylate/2-ethylhexyl acrylate-based block copolymers, and combination thereof. It is preferably to use acrylic block polymers derived from both soft monomers and hard monomers. Commercially available acrylic polymers used as component (A) include but not limited to n-butyl acrylate-methyl methacrylate copolymer under Kuraray™ LA2140 manufactured by SANYO and the like.

The styrene block copolymers having a weight-molecular weight (Mw) no less than 10,000 g/mol and an optimum activation temperature of no greater than 100° C. used as component (A) includes an aromatic vinyl polymer block and a saturated midblock, preferably a hydrogenated conjugated diene polymer block, or an unsaturated midblock. The blocks can be arranged in a variety of configurations including, e.g., linear, branched, radial, star and combinations thereof. The aromatic vinyl polymer block can be derived from a variety of aromatic vinyl compounds including, e.g., styrene, alpha-methylstyrene, beta-methylstyrene, o-, m-, p-methylstyrene, t-butylstyrene-2,4,6-trimethylstyrene, monofluorostyrene, difluorostyrene, monochlorostyrene, dichlorostyrene, methoxystyrene, 1,3-vinylnaphthalene, vinylanthracene, indene, acenaphthylene, and combinations thereof. The hydrogenated diene polymer block can be derived from a variety of diene-containing compounds including, e.g., isoprene, butadiene, hexadiene, 2,3-dimethyl-1,3-butadiene, 1,3-pentadiene, and combinations thereof. Useful styrene block copolymers having saturated midblock as component (A) include, e.g., triblock, multi-arm, and radial copolymers including, e.g., styrene-ethylene/butene-styrene (SEBS), styrene-ethylene/propylene-styrene (SEPS), styrene-ethylene-ethylene/propylene-styrene (SEEPS), styrene/isobutylene/styrene (SIBS), and combinations thereof. Useful styrene block copolymers having unsaturated midblock as component (A) include styrene-butadiene-styrene (SBS), styrene-isoprene-styrene (SIS), styrene-butadiene-isobutylene-styrene (SBBS), styrene-isoprene-butadiene-styrene (SIBS), and combination thereof. Commercially available styrene block copolymers used as component (A) include but not limited to HYBRAR™ 5125 and 7311 from Kuraray.

The ethylene-vinyl acetate copolymers having a weight-molecular weight (Mw) no less than 10,000 g/mol and an optimum activation temperature of no greater than 100° C. used as component (A) are copolymers that are derived from at least one ethylene monomer and at least one vinyl acetate monomer. From the perspective of strength and flexibility of the adhesive film derived from the Composition, preferably the ethylene-vinyl acetate copolymers used as component (A) has a vinyl acetate content of 65 mass % or greater. Commercially available ethylene-vinyl acetate copolymers used as component (A) include but not limited to Levamelt™ 686 from ARLANXEO (68 wt % vinyl acetate), KBE-68 A and KBE-68 B manufactured by Kuraray Co., Ltd., and the like.

Other useful thermoplastic polymer having a weight-molecular weight (Mw) no less than 10,000 g/mol and an optimum activation temperature of no greater than 100° C. include but not limited to polyvinyl acetols, styrene acrylonitriles, polyolefins, polyacrylonitriles, ethylene vinyl acetate terpolymers, functional ethylene vinyl acetates, ethylene acrylate copolymers, ethylene acrylate terpolymers, ethylene butadiene copolymers and/or block copolymers, and combination thereof.

The above-mentioned thermoplastic polymers can be used singly or in combination of two or more thereof. If at least two thermoplastic polymers are used as component (A), each of molecular weight and optimum activation temperature shall fall into the claimed range.

In preferred embodiments, the thermoplastic polymer has a number average molecular weight of from 10,000 to 200,000 g/mol, preferably from 8,000 to 150,000 g/mol, and more preferably from 20,000 to 100,000 g/mol.

With particular preference, the component (A) may be present in an amount of from 1% to 95%, preferably from 10% to 40% by weight, based on the total weight of the Composition.

### (B) Polyester Polyol

According to the present invention, the Composition comprises at least one polyester polyol having a weight-molecular weight (Mw) less than 10,000 g/mol, which can react with component (C) described below to form an effective bonding subject to a heat.

Useful component (B) in the present invention include those carrying at least two hydroxyl groups in one molecule, for example three hydroxyl groups or four hydroxyl groups and having aromatic group(s) in the molecule, preferably has a hydroxyl number of no less than 10 mg KOH/g, preferably greater than or equal to 15 mg KOH/g, much preferably ranging from 20 to 90 mg KOH/g, even much more preferably from 30 to 60 mg KOH/g.

The component (B) used in the present invention preferably is solid at ambient temperature (20° C.). In some embodiments, the component (B) can be selected from amorphous polyester polyol, semi-crystalline polyester polyol, crystalline polyester polyol and combination thereof, from perspective of dissolving in the organic solvent, preferably amorphous polyester polyol, semi-crystalline polyester polyol and combination thereof.

The term “amorphous polyester polyol” used herein means a polyester polyol having no melt transition when measured using Differential Scanning calorimetry (DSC), which does not have a crystalline form. It preferably has a degree of crystallinity by weight of less than 10%, preferably of less than 5%, advantageously of less than 2% and more advantageously still of less than 1%.

The term “semicrystalline polyester polyol” means a polyester polyol comprising crystalline regions and amorphous regions in its structure. It preferably has a degree of crystallinity by weight of at least 20% to less than 80%, preferably of at least 30% to less than 80%, preferably at least 40% and less than 80%.

The term “crystalline polyester polyol” used herein means a polyester polyol having a melt transition when measured using Differential Scanning calorimetry (DSC), which has a crystalline form. It preferably has a degree of crystallinity by weight of at least 80%, preferably of at least 90%.

The degree of crystallinity, denoting the proportion of substance in the crystalline state, can be determined by X-ray diffraction analysis at different angles of incidence, by calorimetric measurements, such as DSC (Differential Scanning calorimetry), or by any other technique which makes it possible to estimate the proportion of crystalline phase of the semicrystalline polyester polyol.

Useful amorphous polyester polyol as component (B) in the present invention includes the reaction product of a polyacid component (e.g., polyacid, polyacid anhydride, polyacid ester and polyacid halide), and a stoichiometric excess of polyol. At least one of the polyacid component and the polyol includes an aromatic group. Suitable polyacids include, e.g., diacids (e.g., dicarboxylic acids), triacids (e.g., tricarboxylic acids), and higher order acids, examples of which include aromatic dicarboxylic acids, anhydrides and esters thereof (e.g. terephthalic acid, isophthalic acid, dimethyl terephthalate, diethyl terephthalate, phthalic acid, phthalic anhydride, methyl-hexahydrophthalic acid, methyl-hexahydrophthalic anhydride, methyl-tetrahydrophthalic acid, methyl-tetrahydrophthalic anhydride, hexahydrophthalic acid, hexahydrophthalic anhydride, and tetrahydrophthalic acid), aliphatic dicarboxylic acids and anhydrides thereof (e.g. maleic acid, maleic anhydride, succinic acid, succinic anhydride, glutaric acid, glutaric anhydride, adipic acid, pimelic acid, suberic acid, azelaic acid, sebacic acid, chlorendic acid, 1,2,4-butane-tricarboxylic acid, decanedicarboxylic acid, octadecanedicarboxylic acid, dimeric acid, dimerized fatty acids, trimeric fatty acids, and fumaric acid), and alicyclic dicarboxylic acids (e.g. 1,3-cyclohexanedicarboxylic acid, and 1,4-cyclohexanedicarboxylic acid), and mixture thereof. Examples of suitable polyols include aliphatic polyols, e.g., ethylene glycols, propane diols (e.g., 1,2-propanediol and 1,3-propanediol), butanediols (e.g., 1,3-butanediol, 1,4-butanediol, and 1,2-butanediol), 1,3-butenediol, 1,4-butenediol, 1,4-butynediol, pentane diols (e.g., 1,5-pentanediol), pentenediols, pentynediols, 1,6-hexanediol, 1,8-octanediol, 1,10-decanediol, neopentyl glycol, diethylene glycol, triethylene glycol, tetraethylene glycol, polyethylene glycols, propylene glycol, polypropylene glycols (e.g., dipropylene glycol and tripropylene glycol), 1,4-cyclohexanedimethanol, 1,4-cyclohexanediol, dimer diols, bisphenol A, bisphenol F, hydrogenated bisphenol A, hydrogenated bisphenol F, glycerol, tetramethylene glycol, polytetramethylene glycol, 3-methyl-1,5-pentanediol, 1,9-nonanediol, 2-methyl-1,8-octanediol, trimethylolpropane, pentaerythritol, sorbitol, glucose, and combinations thereof.

Specific examples of useful amorphous polyester polyols include poly(hexanediol phthalate) polyol, poly(neopentyl glycol adipate) polyol, poly(neopentyl glycol phthalate) polyol, poly(neopentyl glycol hexanediol phthalate) polyol, poly(diethylene glycol phthalate) polyol, poly(ethylene glycol adipic acid terephthalate) polyol, polyethylene terephthalate polyols, random copolymer diols of ethylene glycol, hexane diol, neopentyl glycol, adipic acid and terephthalic acid, and combinations thereof.

When solid amorphous polyester polyol is used, it is preferable for it to have a softening point of no greater than 130° C., preferably no greater than 120° C., preferably no greater than 105° C., for example, 60° C., 80° C., 100° C., from the viewpoints of achieving good bonding strength when fully cured, and easy to dissolve in the Composition.

Suitable crystalline polyester polyols as component (B) in the present invention can be obtained by ring opening polymerization of a lactone such as ε-caprolactone and/or be derived from diols and diacids. Examples of diols useful in preparing preferred polyester polyols include ethylene glycol, diethylene glycol, 1,3-propylene glycol, 1,4-butanediol, 1,5-pentanediol, 1,6-hexanediol, 1,8-octanediol, 1,10-decanediol, and combinations thereof. Examples of diacids useful in preparing preferred polyester polyols include succinic acid, glutaric acid, adipic acid, suberic acid, azelaic acid, sebacic acid, and 1,12-dodecanedioic acid, dimer acid, and combinations thereof. Included within the scope of useful diacids are various diacid derivatives such as carboxylate esters (especially the methyl and ethyl esters), acid halides (such as acid chlorides) and acid anhydrides, and combination thereof.

Specific examples of suitable crystalline polyester polyols include poly(hexanediol adipate) polyol, poly(butanediol adipate) polyol, poly-epsilon-caprolactone polyol, poly(hexanediol dodecanedioate) polyol, poly(hexanediol adipic acid terephthalate) polyol, and combinations thereof.

The above-mentioned polyester polyol can be used singly or in combination of two or more thereof. If at least two polyester polyols used in the Composition, each one of weight-molecular weight shall fall into the claimed range.

Suitable commercially available polyester polyols (B) are sold under FZPE-A03130 from GUANGZHOU FTRT CHEMICAL CO., LTD, DYNACOLL 7110, 7130, 7140 and 7150 from Evonik Industries AG, and FLP PA-1000N from Xuchuan Chemical (Suzhou) Co., Ltd. and the like.

With particular preference, the component (B) may be present in an amount of from 0.01% to 80%, preferably from 5% to 40%, based on the total weight of the Composition.

### (C) Polyisocyanate

According to the present invention, the Composition comprises (C) at least one polyisocyanate having at least two isocyanate groups and at least one uretdione group in one molecule.

Useful polyisocyanate(s) (C) which can be used according to the invention correspond(s) to the following formula (I):

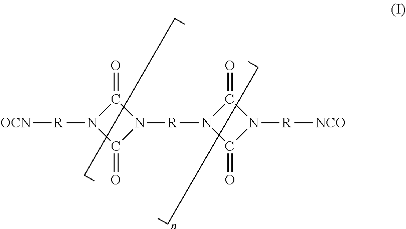

in which:
R is a divalent group comprising from 6 to 13 carbons and
n is an integer ranging from 0 to 10.

Preferably, R is a divalent aromatic or polyaromatic group, more preferably resulting from an aromatic diisocyanate, such as toluene diisocyanate (TDI) or diphenylmethane diisocyanate (MDI).

Examples of the polyisocyanate(s) (C) which can be used according to the invention correspond(s) to one of the following formulae (1-1) or (1-2):

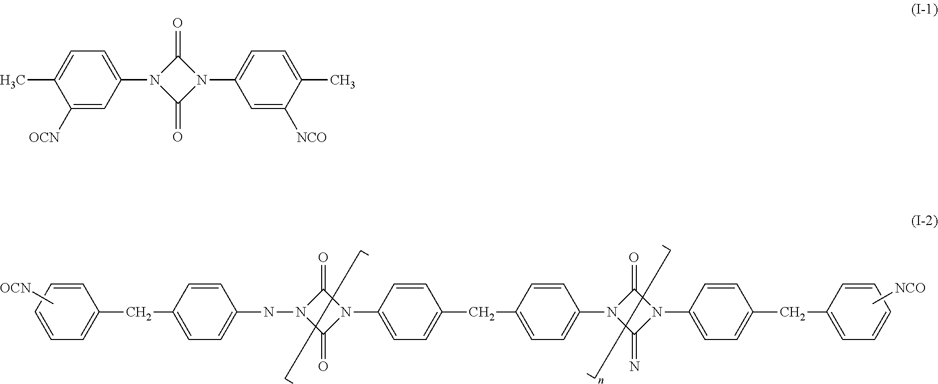

Preferably, the polyisocyanate(s) (C) which can be used according to the invention exhibit(s) a content of NCO (denoted % NCO) ranging from 15% to 40% by weight, more preferably from 20% to 35% by weight, with respect to the weight of said polyisocyanate.

Preferably, the Composition of NCO/OH molar ratio ranges from 0.1 to 8. The isocyanate groups are contributed by component (C) present in the Composition according to the invention and the hydroxyl groups are contributed by the component (B) and minor hydroxy groups in component (A), if any, according to the invention. Under the condition that the above molar ratio is satisfied, the weight percentages of the polyester polyol (B) and the polyisocyanate (C) are not particularly limited.

Suitable commercially available polyisocyanates (C) are sold under the Grilbond™ A2bond (MDI uretdione), sold by EMS-Griltech, Addolink™ TT (TDI uretdione), sold by Rhein Chemie.

With particular preference, the component (C) may be present in an amount of from 0.05% to 20%, preferably from 0.5% to 5% by weight, based on the total weight of the Composition.

### (D) Organic Solvent

According to the present invention, the Composition comprises (D) at least one organic solvent, wherein the organic solvent is present in an amount of greater than 36% to 95%, preferably from 50% to 85% by weight based on the total weight of the Composition.

The organic solvent (D) which can be used according to the invention is (are) preferably such that the component (A) and (B) as well as other optional component or additive are soluble in the organic solvent (D) forming a mixture, and the component (C) can disperse homogeneously in the said mixture.

Preferably, the organic solvent (D) has a solubility parameter, delta (δ) (also known as Hildebrand solubility parameter, HSP), ranging from 6.9 to 10.0 (cal/cm³)^{1/2} and a hydrogen bonding index (HBI), gamma (γ), ranging from 5.0 to 7.7. These parameters are defined in a well-known way in the literature, such as, for example, in sections 38 and 39 of the patent application US 2004/0204524:
the solubility parameter delta is defined in Römpp Lexikon Lacke and Druckfarben, Georg Thieme Verlag, Stuttgart, New York, 1998, “Solubility parameters”, pp 361 to 365;
the hydrogen bonding index describes the ability of a solvent molecule to form hydrogen bonds. The donor solvents have a negative hydrogen bonding index and the acceptor solvents have a positive hydrogen bonding index. The hydrogen bonding index is determined according to the deviation of the infrared band for the RO—H stretching band (R. C. Nelson, R. W. Hemwall and G. D. Edwards, Journal of Paint Technology, “Treatment of hydrogen bonding in predicting miscibility”, Vol. 42, No. 550, 1970, pp 636 to 643).

Preferably, the organic solvent (D) is selected from groups consisting of ketones, preferably aliphatic ketones, more preferably the groups consisting of acetone, methyl ethyl ketone (MEK), 2-pentanone, 3-pentane, methyl isobutyl ketone, ethyl acetate and combination thereof.

Preferably, the organic solvent (D) has a boiling point of less than the optimum activation temperature of the thermoplastic polymer (A) to ensure the organic solvent can be evaporated to form the thermal curable adhesive film without activating the thermoplastic polymer (A), for example, less than 100° C., more preferably less than 80° C.

The above-mentioned component (D) can be used singly or in combination of two or more thereof.

### Composition

In addition, the Composition according to the invention may or may not comprise at least one optional component selected from polyols different from component (B) e.g. polyether polyols, silanes, pigments e.g. carbon black, defoamer agents, leveling agents, stabilizers (antioxidant, UV stabilizer, heat stabilizer), catalysts, dyes and their mixtures, subject to not modifying the advantageous properties of the Composition according to the invention.

The Composition according to the invention can additionally comprise from 1% to 10% by weight of at least one optional additive as defined above.

In particular preferred embodiments, the Composition comprises:
(A) from 1% to 95%, preferably from 10% to 40% by weight of at least one thermoplastic polymer having a weight-molecular weight (Mw) no less than 10000 g/mol and exhibiting an optimum activation temperature of no greater than 100° C., preferably less than 85° C., preferably from 30° C. to less than 80° C., much preferably from 30° C. to less than 70° C., even much preferably from 30° C. to less than 60° C.
(B) from 0.01% to 80%, preferably from 5% to 40% by weight of at least one polyester polyol having a weight-molecular weight (Mw) less than 10000 g/mol,
(C) from 0.05% to 20%, preferably from 0.5% to 5% by weight of at least one polyisocyanate having at least two isocyanate groups and at least one uretdione group in one molecule, and
(D) from greater than 36% to 95%, preferably from 50% to 85% by weight of at least one organic solvent;
based on the total weight of the Composition.

### Thermal Curable Adhesive Film and Preparation Method

According to the second aspect of the invention, the invention relates to a method for preparing a thermal curable adhesive film derived from the Composition described above, comprising the following steps:
1) preparation of a Composition according to the invention by dispersing the component (C) in a mixture comprising at least one component (A), at least one component (B), at least one component (D) and optional component or additive, as are defined above; optionally 1a) the Composition obtained from step 1) is applied onto a detachable liner; and
2) removal of the component (D) from the Composition obtained from step 1) or 1a).

During the step 1), the component (A), the component (B) and optional component or additive are dissolved in the organic solvent (D), preferably under hot conditions, for example at a temperature of less than or equal to 75° C., preferably of less than or equal to 65° C., before introducing the component (C), with rapid stirring, and then component (C) can be added at room temperature, so as to obtain a homogeneous mixture or a homogeneous dispersion.

In some embodiments, the detachable liner used in the step 1a) has a non-stick surface where the Composition is applied onto. Specifically, the Composition is applied as a uniform layer to the non-stick surface of a detachable liner, such as a silicone-treated surface. Application can be carried out in particular using a film applicator or bar coater. On conclusion of steps 1), 1a) and 2), a thermal curable adhesive film in monolayer form is advantageously obtained.

During the process, the apparatuses for these mixing, stirring, dispersing, and the like are not particularly limited. There can be used an automated mortar, a Henschel mixer, a three-roll mill, a ball mill, a planetary mixer, a bead mill, and the like which are equipped with a stirrer and a heater. Also, an appropriate combination of these apparatuses may be used. The preparation method of the Composition is not particularly limited, as long as the above-described components are uniformly mixed.

According to a third aspect, the invention relates to a thermal curable adhesive film, obtained from the method according to the invention.

According to the present invention, the thermal curable adhesive film, comprising:
(A) from 1% to 95%, preferably from 30% to 90% by weight of at least one thermoplastic polymer having a molecular weight (Mw) no less than 10000 g/mol and exhibiting an optimum activation temperature of no greater than 100° C., preferably less than 85° C., preferably from 30° C. to less than 80° C., much preferably from 30° C. to less than 70° C., even much preferably from 30° C. to less than 60° C.,
(B) from 0.01% to 80%, preferably from 10% to 50% by weight of at least one polyester polyol having a molecular weight (Mw) less than 10000 g/mol,
(C) from 0.1% to 20%, preferably from 1% to 10% by weight of at least one polyisocyanate having at least two isocyanate groups and at least one uretdione group in one molecule, and
(D) less than 2.0% by weight, preferably less than 0.5% by weight, preferentially less than 0.1% by weight of at least one organic solvent;
all above based on the total weight of the thermal curable adhesive film.

The thermal curable adhesive film according to the invention can additionally comprise at least one optional component as defined above.

The thermal curable adhesive film according to the invention has a self-supporting feature. The term “self-supporting adhesive film” means an adhesive film that maintains its integrity in the absence of any substrate. In the content of the present invention, a “liner” or “detachable liner” is not considered a substrate.

The thermal curable adhesive film according to the invention preferably has a total thickness ranging from 3 μm to 500 μm.

The thermal curable adhesive film according to the invention preferably exhibits a push-out strength of at least 3 MPa, preferably at least 3.5 MPa.

The thermal curable adhesive films according to the invention are ready-for-use and can be rapidly crosslinked on a substrate or between several substrates, unlike solvent-based adhesive compositions, which have to be dried before crosslinking. It has been observed that, for the thermal curable adhesive film according to the invention with a thickness of 100 μm, the crosslinking time is approximately 10 minutes at 80° C.

### Article

According to the fourth aspect, provided herein is an article comprising:
a first substrate,
a second substrate, and
the thermal curable adhesive film according to the present invention disposed between the first substrate and the second substrate.

In another embodiment, an article includes a first substrate, a second substrate, and a thermal curable adhesive film of the invention disposed between the two substrates, and in direct contact with the two substrates.

The first substrate and/or second substrate can be of a single material and a single layer or can include multiple layers of the same or different material. The layers can be continuous or discontinuous.

The substrates of the article descried herein can have a variety of properties including rigidity (e.g., rigid substrates i.e., the substrate cannot be bent by an individual using two hands or will break if an attempt is made to bend the substrate with two hands), flexibility (e.g., flexible substrates i.e., the substrate can be bent using no greater than the force of two hands), porosity, conductivity, lack of conductivity, and combinations thereof.

The substrates of the article can be in a variety of forms including, e.g., fibers, threads, yarns, wovens, nonwovens, films (e.g., polymer film, metallized polymer film, continuous films, discontinuous films, and combinations thereof), foils (e.g., metal foil), sheets (e.g., metal sheet, polymer sheet, continuous sheets, discontinuous sheets, and combinations thereof), and combinations thereof.

In preferred embodiments, at least one of the substrates can be selected from metals, such as metal firing pastes, anodic aluminum, tin, molybdenum, silver, conductive metal oxides such as indium tin oxide (ITO), fluorine doped tin oxide, aluminum doped zinc oxide etc., glasses such as inked glass, bare glass, resins such as polycarbonate, polybutylece terephthalate and polyamide. Further suitable metals include copper, gold, palladium, platinum, aluminum, indium, silver coated copper, silver coated aluminum, tin, and tin coated copper. Preferably both substrates are selected from one of the aforementioned materials.

According to an alternative form of this preferred embodiment, the article can be a multilayer one by laminating more substrates using the thermal curable adhesive film according to the present invention.

In the case of a monolayer article, the thickness of the film preferably ranges from 3 μm to 500 μm. In the case of a multilayer article, the thickness of the film preferably ranges from 10 μm to 1000 μm.

In one embodiment, an article having a first substrate and a second substrate is prepared by contacting a first substrate with a first major surface of any one of the thermal curable adhesive films, contacting the second substrate with a second major surface of the film such that the second major surface of the film is in direct contact with the second substrate to form the article, and applying heat at a temperature of less than 100° C. preferably from 60° C. to 80° C. and optional pressure to the article to cure the adhesive film such that the two substrates are adhered together.

In another embodiment, an article having a first substrate and a second substrate is prepared by contacting a first substrate with a first major surface of any one of the thermal curable adhesive films, applying heat at a temperature of from 40° C. to 60° C. to the adhesive film before or after the adhesive film is applied to the first substrate to from a pre-laminate, which could be stored and transported to a different location. During the pre-lamination, partially coalescence can occur in thermoplastic polymer (A) while the composition has not started to cure or crosslink. Once ready, the pre-laminate is used to make the final article by contacting the second substrate with a second major surface of the film such that the second major surface of the film is in direct contact with the second substrate to form the article, and applying heat at a temperature of less than 100° C. preferably from 60° C. to 80° C. and optional pressure (e.g. membrane or bladder press, heated platens) to the article to cure the adhesive film such that two substrates are adhered together through the adhesive film.

The Composition can be applied to a substrate using any suitable application method including, e.g., automatic fine line dispensing, jet dispensing, slot die coating, roll coating, gravure coating, transfer coating, pattern coating, screen printing, spray coating, filament coating, by extrusion, air knife, trailing blade, brushing, dipping, doctor blade, offset gravure coating, rotogravure coating, and combinations thereof. The Composition can be applied as a continuous or discontinuous coating, in a single or multiple layers and combinations thereof.

As will be understood, the time and temperature curing profile for each thermal curable adhesive film will vary, and different Compositions can be designed to provide the curing profile that will be suited to the particularly industrial manufacturing process.

### Use

According to a fifth aspect of the invention, provided herein is the use of the Composition according to the present invention or the thermal curable adhesive film according to the present invention or the article according to the present invention in manufacturing automobile parts, truck bed covers, textile laminations, assembled goods, and electronic devices.

The thermal curable adhesive film is useful in a variety of applications including, e.g., temporarily bonding at least one substrate, permanently bonding at least one substrate or two substrates, protecting a substrate, inhibiting or preventing the movement of a first substrate relative to a second substrate, and combinations thereof. The thermal curable adhesive film is also useful in a variety of processes including, e.g., manufacturing processes (e.g., bonding two parts of an article together and maintaining two parts in fixed relation to one another during the manufacturing process), shipping processes, stacking processes, and combinations thereof.

The thermal curable adhesive film can be used in the manufacture of a variety of articles including, e.g., automobile parts, truck bed covers, textile laminations, various assembled goods, and electronic devices.

The said suitable electronic devices includes, but not limited to, e.g., wearable electronic devices (e.g., wrist watches and eyeglasses), handheld electronic devices (e.g., phones (e.g., cellular telephones and cellular smartphones), cameras, tablets, electronic readers, monitors (e.g., monitors used in hospitals, and by healthcare workers, athletes and individuals), watches, calculators, mice, touch pads, and joy sticks), computers (e.g., desk top and lap top computers), computer monitors, televisions, media players, or other electronic components.

### Examples

The following examples are intended to assist one skilled in the art to better understand and practice the present invention. The scope of the invention is not limited by the examples but is defined in the appended claims. All parts and percentages are based on weight unless otherwise stated.

### Raw Materials:

Vitel™ 3300 is a thermoplastic polyester polymer having a weight-molecular weight (Mw) of 63,000 g/mol and an optimum activation temperature of 125° C., available from Bostik.

KURARITY™ LA4285 is a thermoplastic acrylic block copolymer having a weight-molecular weight (Mw) of 40,000 g/mol and an optimum activation temperature of 140° C. to 160° C., available from Kuraray.

HF4003LH-5 is a thermoplastic polyurethane polymer having a weight-molecular weight (Mw) of 80,000 g/mol and an optimum activation temperature of 110° C. to 130° C., available from Huafeng Chemical.

VYLON BX1001 is a thermoplastic polyester polymer having a weight-molecular weight (Mw) of 28,000 g/mol and an optimum activation temperature of 82° C., available from TOYOBO.

Pearlstick™ 45-60/08 a thermoplastic polyurethane polymer having a weight-molecular weight (Mw) of 60,000 g/mol and an optimum activation temperature of 40 to 70° C., available from Lubrizol.

WH6190A is a thermoplastic polyurethane polymer having a weight-molecular weight (Mw) of 50,000 g/mol and an optimum activation temperature of 55° C., available from Wanhua Chemical.

P60/64 is a thermoplastic polyurethane polymer having a weight-molecular weight (Mw) of 60,000 g/mol and an optimum activation temperature of 50° C., available from GUANGZHOU FTRT CHEMICAL CO., LTD.

CAPA™ 6800 is a thermoplastic polyester polymer derived from polycaprolactone monomer having a weight-molecular weight (Mw) of 80,000 g/mol and an optimum activation temperature of 60° C., available from Perstorp.

KURARITY™ LA2140 is a thermoplastic acrylic block copolymer having a weight-molecular weight (Mw) of 40,000 g/mol and an optimum activation temperature of 40° C., available from Kuraray.

HYBRAR™ 5125 is styrene block copolymer having a weight-molecular weight (Mw) of more than 10,000 g/mol and an optimum activation temperature of 80° C., available from Kuraray.

FZPE-A03130 is an amorphous polyester polyol having a weight-molecular weight (Mw) of 3000 g/mol available from GUANGZHOU FTRT CHEMICAL CO., LTD.
Addolink™ TT is TDI uretdione, available from Rhein Chemie.
MEK is methyl ethyl ketone as organic solvent having a boiling point of 70° C. to 80° C., available from Sinopharm.
Silquest A-189 is silane available from Momentive.
Carbon black is pigment available from Cabot.
BYK-141 is defoamer agent available from BYK.
BYK-3550 is leveling agent available from BYK.
   Preparation of the Compositions and the Thermal Curable Adhesive Film Derived from the Compositions According to the Invention (Ex.1 to Ex.7)

The Compositions of Examples 1 to 7 according to the invention were prepared by the components described in table 1 below. The contents shown in table 1 are expressed in grams (g).

The respective thermal curable adhesive films derived from the Compositions according to the invention were prepared according to the following steps:
(1) the thermoplastic polymers (A), the polyester polyol (B) and additives were added into the organic solvent (D) with slow stirring for approximately 10 hours under the temperature of less than 65° C. until the polymers are dissolved;
(2) when dissolved, the solution is cooled to room temperature. The polyisocyanate (C) was subsequently introduced and then the mixture was transferred into a suitable receptacle and placed under rapid stirring using a high-speed mixer for two times 1 minute at 2000 revolutions per minute (rev/min); and
(3) the dispersion obtained from step (2) was drawn over silicone-treated paper using a 500 μm film applicator. The adhesive film was left under suction for 1 hour at room temperature in order to evaporate the organic solvent (D).
   Preparation of the Comparative Compositions (CEx.1 to CEx.5) and their Thermal Curable Adhesive Films (CEx.1 to CEx.4)

The Compositions of Comparative Examples 1 to 5 were prepared by the components described in table 1 below. The contents shown in table 1 are expressed in grams (g).

The thermal curable adhesive films derived from CEx.1 to CEx.4 were prepared in the same way as the Examples 1 to 7 according to the invention, by following the steps described above. The component (A) was replaced with the thermoplastic polymers Vitel™ 3300, KURARITY™ LA4285 and HF4003LH-5 respectively (CEx.2 to 4) or being not added (CEx.1).

The CEx.5 corresponds to the Composition of Example 2 according to the invention in which the weight of organic solvent (D) was in an amount of 35% with respect to the total weight of the Composition, it was observed that it forms a gel rather than a homogeneous mixture therefore cannot be further testing.

### Test Methods:

### Self-Supporting Property:

After evaporation of the organic solvent (D), the self-supporting property of the adhesive films derived from Compositions of the Examples 1 to 7 and Comparative Examples 1 to 4 as prepared above was tested via detaching by hand from the silicone-treated paper. The observation was recorded in Table 2 according to the following scale:
homogeneous film can be formed and detached by hand—◯
homogeneous film cannot be formed e.g. scattered dots and uniform surface—X

### Push-Out Strength:

### Adhesive Film Preparation:

Each Composition of the inventive example and comparative example obtained above was applied onto one surface of a detachable liner. And then they were placed at room temperature for 1 hour to evaporate the organic solvent to form adhesive films, preferably they can be heated from 40° C. to 70° C. to accelerate the evaporation.

### Sample Prelamination:

The adhesive films of the inventive example and comparative example was cut into pieces with each size of 25×25 mm and then pre-laminated using a test coupon on a heating platform. The test coupon consisted of an inked glass block and a window-like component made from anodic aluminum separately. The adhesive film was applied uniformly to the surface of the said inked glass block on the platform under the temperature of 50° C., and 500 g weight was used to press the adhesive film for 30 seconds, and then the liner was removed from the adhesive film. The inked glass block and the window-like component were pressed together with a bonding area of 225 mm², under the temperature of 60° C. and the pressure of 2 kilograms for another 30 seconds. This pre-lamination step helps to activate the coalescence of the thermoplastic polymer with an initial bond.

### Final Lamination/Thermal Curable Process:

The specimen obtained above was transferred to a thermo-compressor to perform the final lamination/thermal curable process under the temperature of 80° C. The thermos-compressor had an upper and bottom flat metal thermos-block (both metal blocks were set up to 80° C. in advance). The final lamination was performed under the pressure of about 2 bar, and heating for 10 minutes at 80° C. (usually, 3 to 6 test specimens was heating pressed at one time), during which the adhesive film crosslinked and cured. The specimen was transferred from the thermos-compressor to room temperature, and then being continuing to compress with 2 kilograms weight for 6 minutes.

### Sample Testing

The push-out strength test was performed using a universal testing machine with a punch at 23±2° C. and 50%+5% relative humidity. The punch applied a compressing force on the metal block of the test coupon at a pushing speed of 2 mm/min till the assembly can no longer support a load. The maximum load was recorded in Table 2, and the push-out strength was calculated from dividing the maximum load by the bonding area.

The adhesive film exhibiting a push-out strength of at least 3 MPa is considered acceptable, preferably at least 3.5 MPa.

TABLE 1

| Components | Raw | | | | | | | | | | | | |
|---|---|---|---|---|---|---|---|---|---|---|---|---|---|
| (g) | Material | CEx. 1 | CEx. 2 | CEx. 3 | CEx. 4 | CEx. 5 | EX. 1 | EX. 2 | EX. 3 | EX. 4 | EX. 5 | EX. 6 | EX. 7 |
| Thermoplastic | Vitel ™3300 | 0 | 25 | 0 | 0 | 0 | 0 | 0 | 0 | 0 | 0 | 0 | 0 |
| polymer | KURARITY ™ | 0 | 0 | 25 | 0 | 0 | 0 | 0 | 0 | 0 | 0 | 0 | 0 |
| | LA4285 | | | | | | | | | | | | |
| | HF4003LH-5 | 0 | 0 | 0 | 25 | 0 | 0 | 0 | 0 | 0 | 0 | 0 | 0 |
| | BX1001 | 0 | 0 | 0 | 0 | 0 | 25 | 0 | 0 | 0 | 0 | 0 | 0 |
| | Pearlstick ™ | 0 | 0 | 0 | 0 | 25 | 0 | 25 | 0 | 0 | 0 | 0 | 0 |
| | 45-60/08 | | | | | | | | | | | | |
| | WH6190A | 0 | 0 | 0 | 0 | 0 | 0 | 0 | 25 | 0 | 0 | 0 | 0 |
| | P60/64 | 0 | 0 | 0 | 0 | 0 | 0 | 0 | 0 | 25 | 0 | 0 | 0 |
| | CAPA ™ | 0 | 0 | 0 | 0 | 0 | 0 | 0 | 0 | 0 | 25 | 0 | 0 |
| | 6800 | | | | | | | | | | | | |
| | KURARITY ™ | 0 | 0 | 0 | 0 | 0 | 0 | 0 | 0 | 0 | 0 | 25 | 0 |
| | LA2140 | | | | | | | | | | | | |
| | HYBRAR ™ | 0 | 0 | 0 | 0 | 0 | 0 | 0 | 0 | 0 | 0 | 0 | 25 |
| | 5125 | | | | | | | | | | | | |
| Polyester | FZPE- | 5 | 5 | 5 | 5 | 5 | 5 | 5 | 5 | 5 | 5 | 5 | 5 |
| polyol | A03130 | | | | | | | | | | | | |
| Organic | MEK | 85 | 85 | 85 | 85 | 20 | 85 | 85 | 85 | 85 | 85 | 85 | 85 |
| solvent | | | | | | | | | | | | | |
| Polyisocyanate | Addolink ™ | 1.20 | 1.20 | 1.20 | 1.20 | 1.20 | 1.20 | 1.20 | 1.20 | 1.20 | 1.20 | 1.20 | 1.20 |
| | TT | | | | | | | | | | | | |
| Additive | Silane | 1 | 1 | 1 | 1 | 1 | 1 | 1 | 1 | 1 | 1 | 1 | 1 |
| | Carbon | 1 | 1 | 1 | 1 | 1 | 1 | 1 | 1 | 1 | 1 | 1 | 1 |
| | black | | | | | | | | | | | | |
| | Defoamer | 1.5 | 1.5 | 1.5 | 1.5 | 1.5 | 1.5 | 1.5 | 1.5 | 1.5 | 1.5 | 1.5 | 1.5 |
| | agent | | | | | | | | | | | | |
| | leveling | 1.5 | 1.5 | 1.5 | 1.5 | 1.5 | 1.5 | 1.5 | 1.5 | 1.5 | 1.5 | 1.5 | 1.5 |
| | agent | | | | | | | | | | | | |

| | | | | | | | | | | | | |
|---|---|---|---|---|---|---|---|---|---|---|---|---|
| Total weight (g) | 96.2 | 121.2 | 121.2 | 121.2 | 56.2 | 121.2 | 121.2 | 121.2 | 121.2 | 121.2 | 121.2 | 121.2 |

TABLE 2

| Testing | | | | | | | | | | | |
|---|---|---|---|---|---|---|---|---|---|---|---|
| results | CEx. 1 | CEx. 2 | CEx. 3 | CEx. 4 | EX. 1 | EX. 2 | EX. 3 | EX. 4 | EX. 5 | EX. 6 | EX. 7 |
| Self- | X | ◯ | ◯ | ◯ | ◯ | ◯ | ◯ | ◯ | ◯ | ◯ | ◯ |
| supporting | | | | | | | | | | | |
| property | | | | | | | | | | | |
| Push-out | N/A | 2.0 | 0.3 | 2.2 | 3.5 | 5.5 | 6.0 | 7.0 | 5.0 | 4.5 | 3.8 |
| strength | | | | | | | | | | | |
| (MPa) | | | | | | | | | | | |

N/A refers to the Composition cannot form a homogeneous adhesive film for further testing.

As can be seen from Table 2, it was observed that once detached, the adhesive films derived from Compositions of Ex. 1 to Ex. 7 were all self-supportive which were sufficiently flexible to be able to be put into the form of a roll. In particular, it was noted that the Compositions of Examples 1 to 7 exhibited a better quality of mixing and were more film-forming, thus making a possible to obtain a thinner and more homogeneous film.

The Composition of CEx.1 corresponds to the Ex. 1 to Ex. 7 according to the invention in which the thermoplastic polymer (A) was not added, it was observed that it cannot form a homogeneous self-supporting film. Compared with the adhesive films derived from CEx. 2 to Ex. 4, the adhesive films derived from Ex. 1 to Ex. 7 exhibited outstanding push-out strength when cured.

Although some preferred embodiments have been described, many modifications and variations may be made thereto in light of the above teachings. It is therefore to be understood that the invention may be practiced otherwise than as specifically described without departing from the scope of the appended claims.

What is claimed is:

1. A Composition, comprising:
(A) at least one thermoplastic polymer having a weight-molecular weight (Mw) no less than 10,000 g/mol and an optimum activation temperature of no greater than 100° C.,
(B) at least one polyester polyol having a weight-molecular weight (Mw) less than 10,000 g/mol,
(C) at least one polyisocyanate having at least two isocyanate groups and at least one uretdione group in one molecule, and
(D) at least one organic solvent, wherein the organic solvent is present in an amount of greater than 36% to 95% based on the total weight of the Composition.

2. The Composition according to claim 1, wherein component (A) has an optimum activation temperature of less than 85° C.

3. The Composition according to claim 1, wherein component (A) is selected from groups consisting of thermoplastic polyurethane polymers, polyester polymers, acrylic polymers, ethylene-vinyl acetate copolymers, styrene block copolymers, polyvinyl acetols, styrene acrylonitriles, polyolefins, polyacrylonitriles, ethylene vinyl acetate terpolymers, functional ethylene vinyl acetates, ethylene acrylate copolymers, ethylene acrylate terpolymers, ethylene butadiene copolymers and/or block copolymers.

4. The Composition according to claim 1, wherein the component (B) is selected from an amorphous polyester polyol, a semi-crystalline polyester polyol, a crystalline polyester polyol and combination thereof.

5. The Composition according to claim 1, wherein the Composition of NCO/OH molar ratio ranges from 0.1 to 8.

6. The Composition according to claim 1, wherein component (D) is selected from groups consisting of ketones.

7. The Composition according to claim 1, wherein the Composition further comprises at least one component selected from a polyol different from component (B), silane, pigment, defoamer agent, leveling agent, stabilizer, dye and their mixtures.

8. The Composition, according to claim 1, comprising:
(A) from 1% to 95% by weight of at least one thermoplastic polymer having a weight-molecular weight (Mw) no less than 10,000 g/mol and exhibiting an optimum activation temperature of no greater than 100° C.,
(B) from 0.01% to 80% by weight of at least one polyester polyol having a weight-molecular weight (Mw) less than 10,000 g/mol,
(C) from 0.05% to 20% by weight of at least one polyisocyanate having at least two isocyanate groups and at least one uretdione group in one molecule, and
(D) from greater than 36% to 95% by weight of at least one organic solvent;
based on the total weight of the Composition.

9. A method for preparing a thermal curable adhesive film, comprising the following steps:
1) preparation of a Composition by dispersing the component (C) in a mixture comprising at least one component (A), at least one component (B), at least one component (D) and optional component or additive according to claim 1;
optionally 1a) the Composition obtained from step 1) is applied onto a detachable liner; and
2) removal of the component (D) from the Composition obtained from step 1) or 1a).

10. The method for preparing a thermal curable adhesive film according to claim 9, wherein the detachable liner in step 1a) has a non-stick surface where the Composition is applied onto.

11. A thermal curable adhesive film obtained from the method of claim 9.

12. A thermal curable adhesive film, comprising:
(A) from 1% to 95% of at least one thermoplastic polymer having a molecular weight (Mw) no less than 10000 g/mol and exhibiting an optimum activation temperature of no greater than 100° C.,
(B) from 0.01% to 80% by weight of at least one polyester polyol having a molecular weight (Mw) less than 10000 g/mol,
(C) from 0.1% to 20% by weight of at least one polyisocyanate having at least two isocyanate groups and at least one uretdione group in one molecule, and
(D) less than 2.0% by weight of at least one organic solvent;
all above based on the total weight of the thermal curable adhesive film.

13. The thermal curable adhesive film according to claim 11, has a total thickness ranging from 3 μm to 500 μm.

14. The thermal curable adhesive film according to claim 11, exhibits a push-out strength of at least 3 MPa.

15. An article comprising:
a first substrate,
a second substrate, and
the thermal curable adhesive film according to claim 11 disposed between the first substrate and the second substrate.
